(19) United States
(12) Patent Application Publication
(10) Pub. No.: US 2015/0040364 A1
(43) Pub. Date: Feb. 12, 2015

(54) REPAIRING METHOD

(71) Applicant: MITSUBISHI HEAVY INDUSTRIES, LTD., Tokyo (JP)

(72) Inventors: Tomoko OGASAHARA, Tokyo (JP); Kosuke NISHIKAWA, Tokyo (JP); Noriyuki HIRAMATSU, Tokyo (JP); Akira FUKUSHIMA, Tokyo (JP)

(73) Assignee: MITSUBISHI HEAVY INDUSTRIES, LTD., Tokyo (JP)

(21) Appl. No.: 14/132,470

(22) Filed: Dec. 18, 2013

(30) Foreign Application Priority Data
Aug. 9, 2013 (JP) 2013-166476

(51) Int. Cl. B23P 6/04; B23K 26/34; B23K 1/005

(52) U.S. Cl. CPC B23P 6/04; B23K 1/0056; B23K 26/345
USPC 29/402.07; 29/402.18; 219/76.1; 219/121.66

(57) ABSTRACT

A repairing method includes heating a base material by a heater, and irradiating a laser beam to a repair region of the base material by using a laser oscillator unit, after the base material is heated. In the method, generation of a crack and a break can be suppressed, and the repair region can be repaired more appropriately.

### CROSS REFERENCE

This application claims a priority on convention based on Japanese Patent Application NO. 2013-166476. The disclosure thereof is incorporated herein by reference.

### TECHNICAL FIELD

The present invention relates to a repairing method, and more particularly relates to a repairing method used when a defect generated in a base material is repaired.

### BACKGROUND ART

A TiAl intermetallic compound that contains titanium and aluminum is known. The TiAl intermetallic compound is applied to parts that are required to be high in heat resistance and light in weight. As the parts, parts for a flying vehicle and an aerospace engine are exemplified. When the TiAl intermetallic compound is mechanically worked, a crack and a break are easily generated therein. When the crack and break are generated in the part, a build-up welding is required to be performed on a region where the crack and the break are generated. The part made of the TiAl intermetallic compound is typically brittle. Also, when the same filler material as the base material is used for the build-up welding, a residual stress generated in the build-up welding portion is high, and the ductility is low. Therefore, the break is easily generated, and a repairing work is difficult. For this reason, a brazing work is applied to the build-up welding for the part made of the TiAl intermetallic compound by using the filler material different from the TiAl intermetallic compound. It is desired to adequately repair the brittle base material that is exemplified by the TiAl intermetallic compound.

Japanese Patent No. 3,741,547 discloses a bonding method of using a diffusion brazing work to a part made of titanium aluminide and can attain a sufficient quality standard which is especially required in an aircraft field. The bonding method includes (a) a step of preparing a homogeneous powder mixture of a powder A and a powder B, (b) a step of mixing an organic binder with the powder mixture obtained at the step (a) to prepare a paste, (c) a step of depositing the paste to cover a bonding gap of the part, and (d) a step of heating an assembly obtained at the step (c) in a vacuum furnace of a temperature between 1000° C. and 1300° C. for several minutes to six hours. The powder A is made of a titanium alminide alloy corresponding to the weight ratio of 40 to 90% of a total amount of the homogenous powder mixture. The powder B is made of an alloy, which has a melting point lower than the melting start temperature of the powder A, and contains as a base, titanium or copper by which the powder A can be chemically moistened. The powder B corresponds to the weight ratio of 10 to 60% of the total amount of the homogeneous powder mixture (in this case, the weight ratio between the powder A and the powder B is determined on the basis of an operation parameter, a temperature and a granularity of a powder in the method).

JP 2010-203258A discloses a repairing method of a rotor blade that can be used without any trouble even if a repaired rotor blade is applied to a rotating machine such as a gas turbine. In the repairing method of the rotor blade, a fin attached to an outer surface of a tip shroud is repaired. In the repairing method, a powder build-up welding is carried out by using a laser apparatus while a powder of particles of heat-resistant superalloy which contains Al in a range 3 wt % to 5 wt % and Ti in a range 2 wt % to 3.5 wt % is blown to the surface of the fin, thereby repairing the damaged fin.

### CITATION LIST

[Patent Literature 1] Japanese Patent No. 3,741,547

[Patent Literature 2] JP 2010-203258A

### SUMMARY OF THE INVENTION

An object of the present invention is to provide a repairing method of repairing a base material more appropriately.

Another object of the present invention is to provide a repairing method of reducing generation of a crack in a repair region of the base material.

Another object of the present invention is to provide a repairing method of building up a base material more appropriately.

A repairing method of the present invention is provided with a step of heating a base material, and a step of irradiating a laser beam to a repair region after the repair region of the base material is heated. Such a repairing method can reduce generation of the crack and the break in repair region, as compared with another repairing method of irradiating a laser beam to the repair region without preheating the base material. As a result, the repairing method of the present invention can repair the repair region more appropriately.

The base metal is formed of intermetallic compound which contains titanium and aluminum. The intermetallic compound has a γ phase, a β phase and an α2/γ lamellar phase. At this time, the laser beam is irradiated to the repair region while the temperature of the base material is in a range of 500° C. to 800° C. Such a repairing method can reduce the generation of the crack and the break in the repair region, as compared with the other repairing method of irradiating the laser beam when the temperature of the base material is less than 500° C. Also, the repairing method can repair the repair region more appropriately. Moreover, such a repairing method can reduce oxidization of the repair region, as compared with the other repairing method of irradiating the laser beam when the temperature of the base material is equal to or more than 800° C., and can repair the repair region more appropriately.

A repairing method of the present invention is further provided with a step of blowing a powder which is formed from the material of the base material, to the repair region. The laser beam is irradiated to the repair region while the powder is blown out. Such a repairing method can build up the repair region and can repair the repair region more appropriately. Moreover, such a repairing method can restore the repair region such that the repair region has a predetermined coupling strength, by building up with the same material as the base material. As a result, the repairing method of the present invention can repair the repair region more appropriately, as compared with another repairing method of blowing out a powder which is formed from a material which is different from the base material, to the repair region.

The particle diameter of the powder is equal to or more than 50 μm and equal to or less than 150 μm. The powder that the particle diameter is less than 50 μm is sometimes flied off when it is blown to the repair region. Therefore, such a repairing method can supply the filler material to the repairing region more efficiently, as compared with another repairing method of blowing the powder of particles having the particle diameters less than 50 μm, and the repair region can be repaired more appropriately. It is difficult for the powder of particles having particle diameters more than 150 μm to fuse through the irradiation of the laser beam, as compared with the powder of particles having particle diameters equal to or less than 150 μm. Therefore, such a repairing method can fuse the powder more efficiently and repair the repair region more appropriately, as compared with another repairing method of blowing a powder of particles having particle diameters more than 150 μm.

The repairing method of the present invention is further provided with a step of irradiating another laser beam to the repair region while another powder is blown to the repair region a predetermined time period after the powder is blown to the repair region. Such a repairing method can build up the repair region more by repeating plural times, an operation of irradiating the laser beam while the powder is blown to the repair region, and the repair region can be repaired more appropriately. The base material is cooled when the powder is blown. Such a repairing method can prevent the laser beam from being irradiated to the base material when the base material is not sufficiently heated, and the repair region can be repaired more appropriately.

A repairing method of the present invention is further provided with a step of forming a groove into the base material from the surface of a thickness reducing section formed in the repair region. The laser beam is irradiated to the repair region such that the groove is filled with the fused metal obtained by melting the powder after the groove is formed. Such a repairing method can repair the repair region more appropriately by removing the surface of the thickness reducing section even when the surface of the thickness reducing section is oxidized or polluted.

A repairing apparatus of the present invention is provided with a heater configured to heat a base material formed of an intermetallic compound and a laser oscillator unit configured to irradiate a laser beam to a repair region. Such a repairing apparatus can reduce generation of a crack and a break in a repair region by irradiating a laser beam to the repair region after the repair region of the base material is heated. As a result, the repairing apparatus by the present invention can repair the repair region more appropriately.

The repairing apparatus of the present invention is further provided with a powder supplying section configured to blow a powder formed from a material of the base material, to repair region. The laser beam is irradiated to the repair region while the powder is blown. Such a repairing apparatus can build up a thickness reducing section of the base material formed in the repair region and the repair region can be repaired more appropriately.

The repairing apparatus of the present invention is further provided with a shield chamber configured to generate an atmosphere filled with an inert gas. The laser is irradiated to the repair region when the base material is arranged in the atmosphere. Such a repairing apparatus can prevent the repair region from being oxidized and the repair region can be repaired more appropriately.

The method of present invention's repairing can reduce that the division occurs to the repair region by heating the base material before irradiating a laser to the region of the repair of the base material and can do a recondition thing more appropriately in the repair region.

### BRIEF DESCRIPTION OF THE DRAWINGS

FIG. 1 is a block diagram showing a repairing apparatus for performing a repairing method according to the present invention;

FIG. 2 is a cross-sectional view showing a defect that is generated in a base material;

FIG. 3 is a cross-sectional view showing a groove formed in the base material;

FIG. 4 is a cross-sectional view showing a welding portion that is formed in the base material through a seal pass welding operation;

FIG. 5 is a cross-sectional view showing a plurality of beads formed in the base material in a build-up welding operation;

FIG. 6 is a cross-sectional view showing another groove formed in the base material;

FIG. 7 is a cross-sectional view showing a still another groove formed in the base material;

FIG. 8 is a cross-sectional view showing a plurality of beads formed in the base material through another build-up welding operation;

FIG. 9 is a cross-sectional view showing a plurality of beads formed in the base material through a still another build-up welding operation;

FIG. 10 is a cross-sectional view showing a plurality of beads formed in a portion in which the thickness of the base material is decreased;

FIG. 11 is a cross-sectional view showing a plurality of beads formed in a portion in which the base material is cracked; and

FIG. 12 is a cross-sectional view showing the build-up welding of the base material that is repaired by only the seal pass welding.

### DESCRIPTION OF EMBODIMENTS

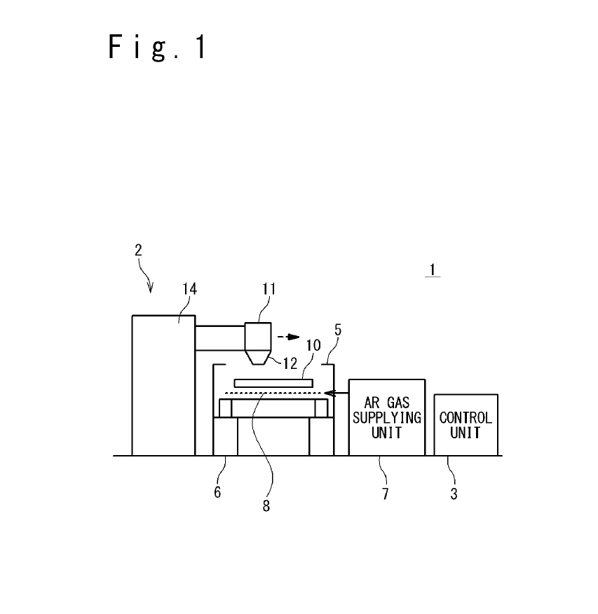

Hereinafter, a repairing apparatus according to embodiments of the present invention will be described in detail with reference to the attached drawings. A repairing apparatus 1 contains a main section 2 and a control unit 3, as shown in FIG. 1. The main section 2 of the repairing apparatus contains a shield chamber 5, a table 6, an argon gas supplying unit 7 and a heater 8. The shield chamber 5 is formed as a container in which a base material 10 can be accumulated. In the shield chamber 5, an opening is formed in the upper portion to connect the inside of the container and the outside of the container. The table 6 is arranged inside the shield chamber 5 to support the base material 10 so that the base material 10 is held in a predetermined attitude. A proper hole is formed in the lower portion of the shield chamber 5, and the argon gas supplying unit 7 supplies an argon gas through the hole to the inside of the shield chamber 5. The heater 8 heats a heating target with radiation heat. The base material 10 is arranged inside the shield chamber 5, and the heater 8 is controlled by the control unit 3 to heat the base material 10.

The base material 10 is made of an intermetallic compound that contains titanium and aluminium. The intermetallic compound has a γ phase, a β phase and an α2/γ lamellar phase. Such an intermetallic compound is known, and for example, is disclosed in Japanese Patent No. 3,741,547 and Japanese Patent Publication JP 2010-203258A. The base material 10 is brittle, and a crack and a break are easily generated. The base material 10 is casted to have a predetermined shape. When the base material is casted or worked, there is a case that the crack and the break are generated on a surface.

The main section 2 of the repairing apparatus further contains a laser oscillation unit 11, a nozzle 12 and an actuator or robot 14. The laser oscillation unit 11 contains an optical fiber (not shown). In the optical fiber, one end is connected to a laser oscillator in the laser oscillation unit 11, and the other end is fixed to the nozzle 12 so that the other end is oriented to a direction to which the nozzle 12 is oriented. The laser oscillation unit 11 outputs a laser beam to the one end of the optical fiber, and the laser beam is outputted to the direction in which the nozzle 12 is oriented. The laser beam is irradiated so that the base material 10 is heated. The nozzle 12 contains a base material powder supplying unit and an argon gas supplying unit, which are not shown. The base material powder supplying unit supplies a base material powder to the nozzle 12. The base material powder is made of the intermetallic compound of the base material 10. A particle diameter of particles of the base material powder is exemplified to be in a range of 50 μm to 150 μm. The argon gas supplying unit supplies the argon gas to the nozzle 12. The nozzle 12 blows the base material powder together with the argon gas into a direction to which the nozzle 12 is oriented. The actuator 14 moves the laser oscillation unit 11 so that the laser beam is irradiated to a predetermined region inside the shield chamber 5 and moves the nozzle 12 so that the base material powder is blown to the predetermined region.

The control unit 3 is a computer, and contains CPU, a storage unit and an interface, which are not shown. The CPU executes a computer program installed in the computer to control the storage unit and the interface. The storage unit stores the computer program and temporally stores data generated by the CPU.

The interface outputs data generated by an external unit to the CPU and outputs the data generated by the CPU to the external unit. As the external unit, an input unit, an output unit, a communication unit and a removal memory drive are exemplified. The input unit is operated by an operator to generate data and output the data to the CPU. As the input unit, a keyboard, a pointing device and a touch panel are exemplified. The output unit recognizably outputs the data generated by the CPU to the operator. As the output unit, a display, an acoustic device and a touch panel are exemplified. The communication unit transmits the data generated by the CPU through a communication network to a different computer and outputs data received from the different computer to the CPU through the communication network. The communication unit is further used to download the computer program from the different computer and the computer program is installed in the computer. When a recording medium is inserted, the removal memory drive is used to read data recorded in the recording medium. Moreover, when the non-transitory recording medium in which the computer program is stored is installed, the removal memory drive is used when the computer program is installed in the computer. As the recording medium, a magnetic disc (a flexible disc, a hard disc), an optical disc (CD, DVD), a magnetic optical disc and a flash memory are exemplified. The external unit includes the argon gas supplying unit 7, the heater 8, the laser oscillation unit 11, the nozzle 12 and the actuator 14.

The computer program installed in the control unit 3 is composed of a plurality of computer program sections that instruct the control unit 3 to attain a plurality of functions, respectively. The plurality of functions include a preheating function, a seal pass welding function and a build-up welding function.

In the preheating function, the argon gas is supplied to the inside of the shield chamber 5 so that the base material 10 is arranged in the atmosphere filled with the argon gas when the base material 10 is arranged in a predetermined orientation (attitude). When the atmosphere in which the base material 10 is arranged is filled with the argon gas, the preheating function controls the heater 8 so that the base material 10 is heated to a predetermined preheating temperature. The predetermined preheating temperature is lower than the melting point of the intermetallic compound of the base material 10, and is between 500° C. and 800° C.

The seal pass welding function controls the heater 8 to heat the base material 10 so that the base material 10 is kept at the preheating temperature. While the base material 10 is kept at the preheating temperature, the seal pass welding function controls the nozzle 12 so that the laser beam is irradiated to a portion of the groove formed in the base material 10. While the base material 10 is kept at the preheating temperature, the seal pass welding function further controls the actuator 14 to move the nozzle 12 so that the portion to which the laser beam is irradiated is moved along the groove at a predetermined speed.

The build-up welding function controls the heater 8 to heat the base material 10 so that the base material 10 is kept at the preheating temperature. While the base material 10 is kept at the preheating temperature, the build-up welding function controls the nozzle 12 so that the base material powder is blown to the groove to be deposited in the groove, and also controls the laser oscillation unit 11 so that the blown base material powder is heated to a temperature higher than the melting point of the base material 10 through the irradiation of the laser beam. While the base material 10 is kept at the preheating temperature, the build-up welding function further controls the actuator 14 to move the nozzle 12 so that the base material powder is blown and the portion to which the laser beam is irradiated is moved along the groove in the predetermined speed. The build-up welding function controls the heater 8 to stop heating the base material 10, after a plurality of beads are formed in the groove.

In the base material 10, a plurality of cracks are generated on the surface when the base material 10 is formed, and include a crack generated when the base material 10 is casted, a crack generated when the base material 10 is hot-worked, and a crack generated when the base material 10 is cold-worked.

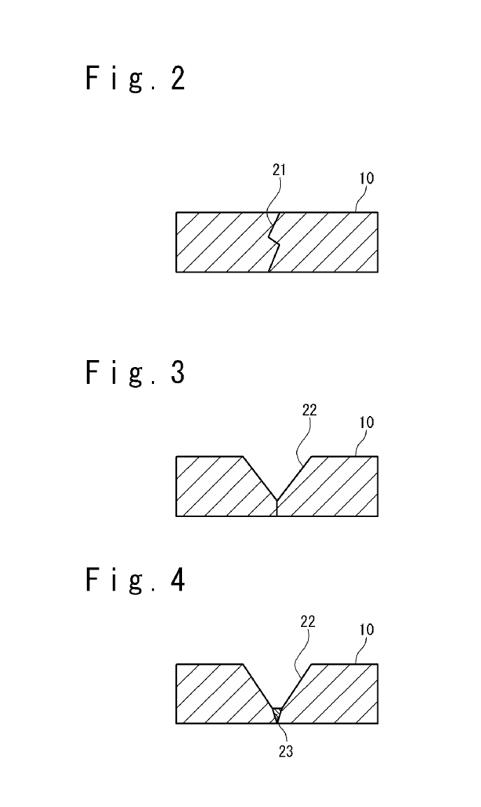

A crack 21 of the plurality of cracks is generated to be split from the surface of the base material 10, as shown in FIG. 2. There is a case that the crack 21 is generated to penetrate from the front side to the rear side of the base material 10. Also, there is a case that an impurity is deposited on the surface on which the crack 21 is generated. As the impurity, floating matters floating in the atmosphere in which the base material 10 is arranged, and an oxide product generated by oxidizing the surface material are exemplified.

The repairing method according to the present embodiment of the present invention contains a groove working operation, a preheating operation, a seal pass welding operation, a build-up welding operation and a finishing operation.

In the groove working operation, a plurality of grooves are formed in correspondence to a plurality of cracks generated in the base material 10. A groove 22 of the plurality of grooves corresponding to the crack 21 is formed as a so-called V-shaped groove, as shown in FIG. 3, and formed such that the entire surface portion of the crack 21 is removed from the base material 10. The groove 22 is formed by operating a tool by a worker.

The preheating operation is executed by the repairing apparatus 1, after the formation of the plurality of grooves. The base material 10 is firstly arranged inside the shield chamber 5 and supported on the table 6 so that the groove 22 of the plurality of grooves is oriented to an upward direction. When the atmosphere in which the base material 10 is arranged is filled with the argon gas, the control unit 3 controls the heater 8 to heat the base material 10 so that the base material 10 arrives at a predetermined preheating temperature. The predetermined preheating temperature is lower than the melting point of the base material 10, and it is between 500° C. and 800° C.

The seal pass welding operation is executed after the execution of the preheating operation. The control unit 3 controls the heater 8 to heat the base material 10 so that the base material 10 is kept at the preheating temperature. The control unit 3 controls the actuator 14 to move the nozzle 12 so that the nozzle 12 is oriented to one end of the groove 22. While the base material 10 is kept at the preheating temperature, the control unit 3 controls the laser oscillation unit 11 to irradiate the laser beam to a portion of the groove 22 such that the portion is heated to a temperature higher than the melting point of the base material 10.

At this time, the portion to which the laser beam is irradiated is melted, and the portion is solidified when the irradiation of the laser beam is stopped. For this reason, according to the above operations, a welding portion 23 is formed along the groove 22 in the base material 10, as shown in FIG. 4. As a result, a gap which penetrates from the front side of the base material 10 to the rear side thereof is caulked and sealed in the groove 22.

The build-up welding operation is executed after the execution of the seal pass welding operation. The control unit 3 controls the heater 8 to heat the base material 10 so that the base material 10 is kept at the preheating temperature. The control unit 3 controls the actuator 14 to move the nozzle 12 to one end of the groove 22 and to operate the nozzle 12 so that the nozzle 12 is oriented to the one end. While the base material 10 is kept at the preheating temperature, the nozzle 12 is controlled to blow the base material powder to the groove 22 so that the base material powder is deposited on the groove 22, and the laser oscillation unit 11 is controlled to irradiate the laser beam so that the blown base material powder is heated to a temperature higher than the melting point of the base material 10.

While the base material 10 is kept at the preheating temperature, the control unit 3 further controls the actuator 14 to move the nozzle 12 so that the base material powder is blown and a portion to which the laser beam is irradiated is moved along the groove 22 from one end of the groove 22 to the other end thereof at a predetermined speed.

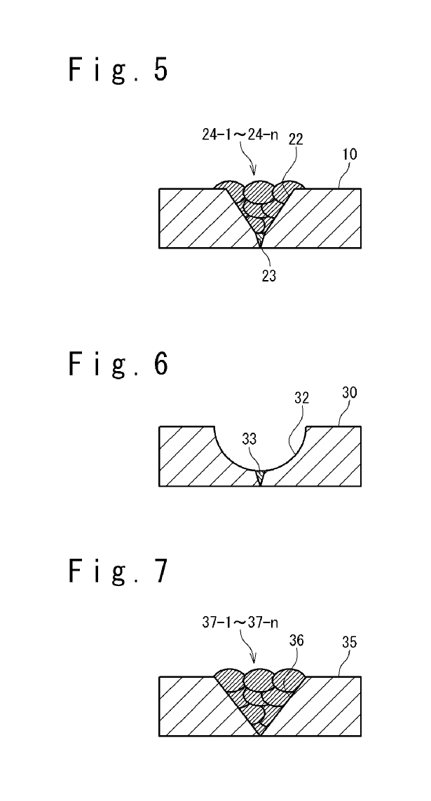

At this time, the base material powder is melted through the irradiation of the laser beam, and the melted filler material is deposited on the inside of the groove 22. The melted filler material deposited on the inside of the groove 22 is solidified when the irradiation of the laser beam is stopped. For this reason, according to the above operation, one bead is formed along the groove 22 of the base material 10. The above operation is repeatedly executed a plurality of times at an interval of a predetermined time. As the predetermined time, three minutes are exemplified. When the above operation is repeatedly executed to the base material 10 n times (n=2, 3, 4, . . . ), as shown in FIG. 5, a plurality of beads 24-1 to 24-n are formed in the inside of the groove 22 so that the groove 22 is embedded. One bead of the plurality of beads 24-1 to 24-n is formed along the groove 22.

After the formation of the plurality of beads 24-1 to 24-n, the control unit 3 controls the heater 8 to stop heating the base material 10 so that the base material 10 is cooled. After the base material 10 is sufficiently cooled, the base material 10 is taken out from the shield chamber 5.

In the finishing operation, the surface of the base material is processed to remove protrusions formed from the plurality of beads 24-1 to 24-n on the surface of the base material 10.

According to the above repairing method, since the welding portion 23 or each of the plurality of beads 24-1 to 24-n is formed while the base material 10 is kept at the preheating temperature, the generation of the crack and the break can be prevented. In addition, the above repairing method can repair the base material 10 more adequately, as compared with another repairing method of forming the welding portion 23 or plurality of beads 24-1 to 24-n at a temperature lower than the preheating temperature.

In the base material 10, when the temperature of the base material 10 is less than 500° C., there is a case that the irradiation of the laser beam causes the break to be generated at the vicinity of the region to which the laser beam is irradiated. However, the repairing method of the present invention can suppress the break from being generated in the base material and adequately repair the base material, as compared with a repairing method of irradiating the laser beam when the temperature of the base material is less than 500° C. Moreover, in the base material 10, when the temperature of the base material 10 is 800° C. or more, there is a case that the region to which the laser beam is irradiated is oxidized through the irradiation of the laser beam. However, the repairing method of the present invention can suppress the repaired region from being oxidized, and can repair the irradiated region more adequately, as compared with a repairing method of irradiating the laser beam when the temperature of the base material is 800° C. or more.

There is a case that, when the base material powder, a particle diameter of whose particle is less than 50 μm, is blown to the base material 10, the base material powder is flied off. However, the repairing method of the present invention can supply filler material to the base material 10 more efficiently and repair the base material 10 more adequately, as compared with a repairing method of blowing the base material powder particles having the particle diameter less than 50 μm to the base material 10. The base material powder of particles having the particle diameter of 150 μm or more is difficult to melt even when of the laser beam is irradiated, as compared with the base material powder of particles having the particle diameter of 150 μm or less. For this reason, the repairing method of the present invention can melt the base material powder more efficiently and can repair the base material 10 more adequately, as compared with a repairing method of blowing the base material powder of particles having the particle diameter of 150 μm or more to the base material 10.

According to the repairing method of the present invention, the plurality of beads 24-1 to 24-n are formed in the groove 22, so that the more build-up welding can be performed in the groove 22, and the base material 10 can be repaired more adequately. Although the base material 10 is cooled when the base material powder is blown, the interval of a predetermined time is set in the repairing method of the present invention, until the formation of another bead after the formation of one bead in the plurality of beads 24-1 to 24-n. Thus, the base material 10 can be kept at the preheating temperature more surely. Therefore, when the base material 10 is not sufficiently heated, the irradiation of the laser beam can be prevented, and as a result of this, the base material 10 can be repaired more adequately.

It should be noted that the V-shaped groove 22 can be replaced with a groove formed to have another shape different from the V-shaped groove. FIG. 6 shows a base material 30 in which the groove is formed. In the base material 30, similarly to the base material 10 in the above-mentioned embodiments, a groove 32 is formed to have a U shape such that the crack is removed from the base material 30. In the base material 30, similarly to the base material 10 in the above-mentioned embodiments, a welding portion 33 can be formed, and a plurality of beads can be formed in the groove 32. Even the repairing method to which the above groove is applied can repair the base material 30 more adequately, similarly to the repairing method in the above-mentioned embodiments.

It should be noted that the repairing method of the present invention may omit the seal pass welding operation. This repairing method can be applied, for example, when the seal pass welding is difficult or when the base material can be repaired sufficiently and adequately even if the seal pass welding is omitted.

FIG. 7 shows a base material 35 repaired by the repairing method in which the seal pass welding operation is omitted. In the base material 35, a V-shaped groove 36 is formed. The base material 35 is small to an extent that it is difficult to perform the seal pass welding to a tip portion of the V-shaped groove 36. In the base material 35, a plurality of beads 37-1 to 37-n are formed without performing the seal pass welding to the tip portion. The above repairing method can be applied when the plurality of beads 37-1 to 37-n are formed such that the base material 35 has a sufficient strength.

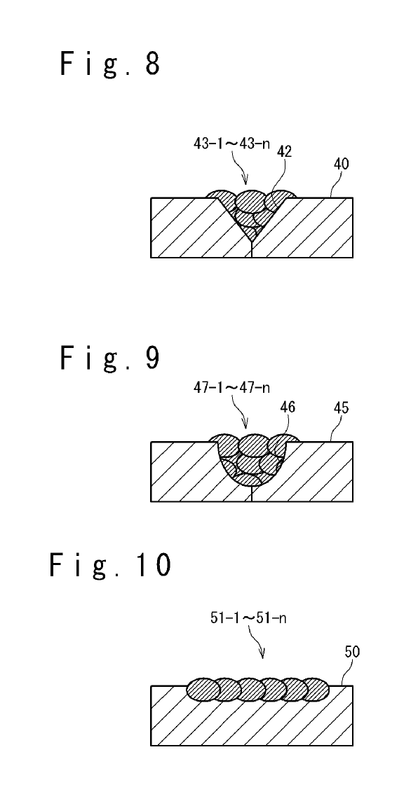

FIG. 8 shows a base material 40 repaired by the repairing method in which the seal pass welding operation is omitted. In the base material 40, a V-shaped groove 42 is formed. In the base material 40, a plurality of beads 43-1 to 43-n are formed without performing the seal pass welding in a tip portion of the V-shaped groove 42. This repairing method can be applied when the plurality of beads 43-1 to 43-n are formed such that the base material 40 has a sufficient strength.

FIG. 9 shows a base material 45 repaired by a still another repairing method in which the seal pass welding operation is omitted. In the base material 45, a U-shaped groove 46 is formed. In the base material 45, the plurality of beads 43-1 to 43-n are formed without performing the seal pass welding in a tip portion of the U-shaped groove 46. This repairing method can be applied when the plurality of beads 43-1 to 43-n are formed such that the base material 45 has a sufficient strength.

In this way, in the repairing method of the present invention, even if the seal pass welding operation is omitted, the plurality of beads are formed while the base material is kept at the preheating temperature. Thus, the crack and the break can be prevented from being generated in the base material, thereby the base material can be repaired more adequately.

It should be noted that the repairing method of the present invention may omit the groove working operation. FIG. 10 shows the base material 50 repaired by the repairing method in which the groove working operation is omitted. A plurality of beads 51-1 to 51-n are formed on the surface of a thickness reducing portion of the base material 50, whose thickness is reduced by a predetermined thickness. The build-up welding operation can be performed on the base material 50 to have an original thickness.

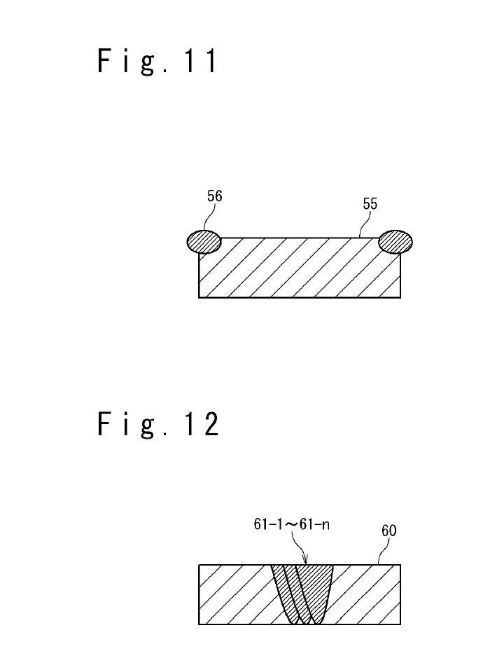

FIG. 11 shows a base material 55 repaired by another repairing method in which the groove working operation is omitted. In the base material 55, the corner of the base material 55 is cracked, and a bead 56 is formed at the cracked corner. The base material 55 can be repaired such that the corner of the base material 55 has a predetermined shape.

In this way, in the repairing method of the present invention, even if the groove working operation is omitted, the bead is formed while the base material is kept at the preheating temperature. Thus, the crack and the break can be prevented from being generated, thereby the base material 55 can be repaired more adequately.

It should be noted that the repairing method of the present invention may omit the build-up welding operation. FIG. 12 shows a base material 60 repaired by another repairing method in which the build-up welding operation is omitted. In the base material 60, extremely small cracks are generated. In such a case, the seal pass welding operation is performed on a portion in which the cracks are generated, to form a plurality of welding portions 61-1 to 61-n. The base material 60 is repaired to have a sufficient strength by forming the plurality of welding portions 61-1 to 61-n to remove the cracks. In this way, in the repairing method of the present invention, even if the build-up welding operation is omitted, the seal pass welding operation is performed while the base material is kept at the preheating temperature. Thus, the crack and the break can be prevented from being generated in the base material, thereby the base material can be repaired more adequately.

It should be noted that the argon gas used in the repairing method of the present invention can be replaced with another inert gas. As the inert gas, helium gas is exemplified. Even the repairing method to which the above inert gas is applied can repair a defect generated in the base material 10 more adequately, similarly to the repairing method in the above-mentioned embodiments.

It should be noted that the groove working operation can be omitted in the repairing method pertaining to the present invention. For example, this repairing method can be applied when the crack 21 is sufficiently large to an extent that the base material paste and brazing filler material can be coated and when a surface of the crack 21 is sufficiently clean to an extent that the surface does not have bad influence on the build-up welding operation. Even the above repairing method can repair a defect generated in the base material 10 more adequately, similarly to the repairing method in the already-explained embodiments.

It should be noted that the repairing method of the present invention can be also applied to a case of repairing a base material made of a metal material different from the intermetallic compound which contains titanium and aluminum. At this time, the preheating temperature is set on the basis of the metal material so that the break becomes difficult to generate or the base material becomes difficult to oxidize. According to the repairing method, the base material can be repaired more adequately, similarly to the base material 10.

It should be noted that in the repairing method of the present invention, the operation of filling the atmosphere where the base material is arranged with the inert gas can be omitted when the metal material is difficult to be oxidized. Even this repairing method can repair a defect generated in the base material more adequately when the base material is welded while the base material is kept at the preheating temperature, similarly to the repairing method in the above-mentioned embodiments.

What is claimed is:

1. A repairing method comprising:
heating a base material; and
irradiating a laser beam to a repair region of the base material after the repair region of the base material is heated.

2. The repair method according to claim 1, wherein the base material is formed of an intermetallic compound which contains titanium and aluminum,
wherein the intermetallic compound has a γ phase, a β phase, and an α2/γ lamellar phase, and
wherein the laser beam is irradiated to the repair region while a temperature of the base material is in a range from 500° C. to 800° C.

3. The repair method according to claim 1, further comprising blowing a powder which comprises a material of the base material, to the repair region,
wherein the laser beam is irradiated to the repair region while the powder is blown to the repair region.

4. The repair method according to claim 3, wherein a particle diameter of particles of the powder is equal to or more than 50 μm and equal to or less than 150 μm.

5. The repair method according to claim 3, further comprising: irradiating another laser beam to the repair region while blowing another powder to the repair region a predetermined time period after the powder is blown to the repair region.

6. The repair method according to claim 3, further comprising:
forming a groove in the base material by removing a surface portion in the repair region,
wherein the laser beam is irradiated to the repair region such that molten metal obtained by melting the powder fills the groove, after the groove is formed.

7. A repairing apparatus comprising:
a heater configured to heat a base material formed of an intermetallic compound; and
a laser oscillator unit configured to irradiate a laser beam to a repair region of the base material.

8. The repairing apparatus according to claim 7, further comprising:
a powder supplying unit configured to blow a powder which is formed of a material of the base material, to the repair region,
wherein the laser beam is irradiated to the repair region while the powder is blown to the repair region.

9. The repairing apparatus according to claim 7, further comprising:
a shield chamber configured to generate an atmosphere which is filled with an inert gas,
wherein the laser beam is irradiated to the repair region when the base material is arranged in the atmosphere.
